(19) United States
(12) Patent Application Publication
(10) Pub. No.: US 2026/0092012 A1
(43) Pub. Date: Apr. 2, 2026

(54) PRODUCING CEMENTITIOUS MATERIALS FROM INERT FILLERS WITH FINE POZZOLANIC PARTICLE COATINGS

(71) Applicant: Wisconsin Alumni Research Foundation, Madison, WI (US)

(72) Inventors: Bu Wang, Madison, WI (US); Raghavendra Ragipani, Kanpur (IN); Qitong Liu, Beijing (CN); Payam Hosseini, McLean, VA (US)

(73) Assignee: Wisconsin Alumni Research Foundation, Madison, WI (US)

(21) Appl. No.: 18/901,857

(22) Filed: Sep. 30, 2024

(51) Int. Cl. C04B 28/18; C04B 7/34

(52) U.S. Cl. CPC C04B 28/18; C04B 7/34

(57) ABSTRACT

A method to produce cementitious materials from low-cost fillers and use of the cementitious materials as supplementary cementitious materials (SCM). The method comprises coating filler particles (e.g., limestone particles) with fine pozzolanic particles (e.g., nanosilica particles), producing composite particles with inert cores and reactive surfaces. When introduced into a cementitious environment, the reactive coating is converted to a binder (e.g., calcium-silicate-hydrate) through pozzolanic or similar reactions, cementing the filler particles together.

### BACKGROUND

Supplementary Cementitious Materials (SCMs) are extensively used in the cement and concrete industry to replace a portion of the main reactive binder in Ordinary Portland Cement (OPC), known as clinker. Clinker production is responsible for the largest proportion of the carbon footprint and energy consumption in the concrete industry (Worrell et al. “Carbon Dioxide Emissions from the Global Cement Industry,” Annu. Rev. Energy Environ. 2001, 26 (1), 303-329; Ali et al. “A Review on Emission Analysis in Cement Industries,” Renew. Sustain. Energy Rev. 2011, 15 (5), 2252-2261). As such, the incorporation of SCMs as a partial clinker replacement successfully reduces a significant amount of CO₂ emissions and energy consumption during cement production while maintaining or enhancing cement performance (Lothenbach et al. “Supplementary Cementitious Materials,” Cem. Concr. Res. 2011, 41 (12), 1244-1256; Thomas et al. “The Effect of Supplementary Cementitious Materials on Chloride Binding in Hardened Cement Paste,” Cem. Concr. Res. 2012, 42 (1), 1-7; Scrivener et al. “Eco-Efficient Cements: Potential Economically Viable Solutions for a Low-CO₂ Cement-Based Materials Industry.” Cem. Concr. Res. 2018, 114, 2-26).

Natural limestone, as a non-pozzolanic SCM, has been widely used as a cement substitute in the production of Portland cement. (See Palm et al. “Cements with a High Limestone Content-Mechanical Properties, Durability and Ecological Characteristics of the Concrete,” Constr. Build. Mater. 2016, 119, 308-318; Miller et al. “Carbon Dioxide Reduction Potential in the Global Cement Industry by 2050,” Cem. Concr. Res. 2018, 114, 115-124; Panesar et al. “Performance Comparison of Cement Replacing Materials in Concrete: Limestone Fillers and Supplementary Cementing Materials-A Review,” Constr. Build. Mater. 2020, 251, 118866; Dhandapani et al. “Towards Ternary Binders Involving Limestone Additions—A Review,” Cem. Concr. Res. 2021, 143, 106396.) As an inert material, limestone acts as a filler that improves particle packing, and its nucleation effect on calcium-silicate-hydrate (C—S—H) promotes early cement hydration (Soroka et al. “Calcareous Fillers and the Compressive Strength of Portland Cement,” Cem. Concr. Res. 1976, 6 (3), 367-376; Soroka et al. “The Effect of Fillers on Strength of Cement Mortars,” Cem. Concr. Res. 1977, 7 (4), 449-456; Cracye et al. “Effect of Mineral Filler Type on Autogenous Shrinkage of Self-Compacting Concrete,” Cem. Concr. Res. 2010, 40 (6), 908-913; Wang et al. “A Review on Use of Limestone Powder in Cement-Based Materials: Mechanism, Hydration and Microstructures,” Constr. Build. Mater. 2018, 181, 659-672). These technical advantages, combined with wide availability and low cost, make limestone a suitable partial replacement for cement clinker. In fact, Portland limestone cement (PLC, Type IL) currently allows up to 15% (by weight) of cement to be replaced by limestone based on ASTM C595 (American Society for Testing and Materials. ASTM C595/C595M-18: Standard Specification for Blended Hydraulic Cements, 2018). As an environmentally and economically friendly solution, PLC is widely accepted in the U.S (Gupta et al. “A Review on Development of Portland Limestone Cement: A Step towards Low Carbon Economy for Indian Cement Industry,” Curr. Res. Green Sustain. Chem. 2020, 3, 100019). However, increasing the limestone content further may lead to the dilution effect, which reduces the cement clinker content and impairs the cement performance, resulting in reduced compressive strength and impaired pore structure. (See Elgalhud et al. “Limestone Addition Effects on Concrete Porosity,” Cem. Concr. Compos. 2016, 72, 222-234.) To address this issue, pozzolanic SCMs have been incorporated into the limestone blended cementitious system to enhance its mechanical and durability properties. (Sec Zelić et al. “The Properties of Portland Cement-Limestone-Silica Fume Mortars,” Cem. Concr. Res. 2000, 30 (1), 145-152; inan Sezer. “Compressive Strength and Sulfate Resistance of Limestone and/or Silica Fume Mortars,” Constr. Build. Mater. 2012, 26 (1), 613-618; Ramczanianpour et al. “A Study on Hydration, Compressive Strength, and Porosity of Portland-Limestone Cement Mixes Containing SCMs,” Cem. Concr. Compos. 2014, 51, 1-13; Hossack et al. “Varying Fly Ash and Slag Contents in Portland Limestone Cement Mortars Exposed to External Sulfates,” Constr. Build. Mater. 2015, 78, 333-341.)

The conventional SCMs rich in silica, such as fly ash, are known to exhibit slow pozzolanic reaction, leading to a decrease in early strength development but beneficial for long-term performance (Lothenbach et al. “Supplementary Cementitious Materials,” Cem. Concr. Res. 2011, 41 (12), 1244-1256; Skibsted et al. “Reactivity of Supplementary Cementitious Materials (SCMs) in Cement Blends,” Cem. Concr. Res. 2019, 124, 105799). However, nano-SiO₂ (nanosilica) particles, which are an ultrafine source of amorphous silica with high purity (>99%), exhibit rapid pozzolanic reactivity, accelerating strength development in the early hydration stage (Khaloo et al. “Influence of Different Types of Nano-SiO₂ Particles on Properties of High-Performance Concrete,” Constr. Build. Mater. 2016, 113, 188-201; Hosseini et al. “Influence of Two Types of Nanosilica Hydrosols on Short-Term Properties of Sustainable White Portland Cement Mortar,” J. Mater. Civ. Eng. 2018, 30 (2), 04017289). The high specific surface area and purity of nanosilica particles promote their pozzolanic reactivity. As a nano-sized SCM, they offer a high specific surface area, providing an increased number of nucleation sites that accelerate the cement hydration process (Björnström et al. “Accelerating Effects of Colloidal Nano-Silica for Beneficial Calcium-Silicate-Hydrate Formation in Cement,” Chem. Phys. Lett. 2004, 392 (1), 242-248; Hosseini et al. “Influence of Nano-SiO₂ Addition on Microstructure and Mechanical Properties of Cement Mortars for Ferrocement,” Transp. Res. Rec. 2010, 2141 (1), 15-20; Land et al. “The Influence of Nano-Silica on the Hydration of Ordinary Portland Cement,” J. Mater. Sci. 2012, 47, 1011-1017). In addition, nanosilica particles can act as ultrafine fillers to refine the microstructure of the cementitious matrix (Bartos et al. Nanotechnology in Construction; Royal Society of Chemistry, 2004). They can also consume portlandite to produce additional C—S—H (Land et al. “The Influence of Nano-Silica on the Hydration of Ordinary Portland Cement,” J. Mater. Sci. 2012, 47, 1011-1017; Gaitero et al. “Reduction of the Calcium Leaching Rate of Cement Paste by Addition of Silica Nanoparticles.” Cem. Concr. Res. 2008, 38 (8), 1112-1118), and densify the microstructure in the weakest area of the concrete, which is the interfacial transition zone between cement paste and aggregates (Nili et al. “Investigating the Effect of the Cement Paste and Transition Zone on Strength Development of Concrete Containing Nanosilica and Silica Fume,” Mater. Des. 2015, 75, 174-183).

However, one of the main challenges associated with the use of nanosilica in the concrete industry is their high tendency to agglomerate due to their high surface energy, which limits their effectiveness (Khaloo et al. “Influence of Different Types of Nano-SiO2 Particles on Properties of High-Performance Concrete,” Constr. Build. Mater. 2016, 113, 188-201). Agglomeration results in large clusters that absorb free water, negatively impacting the fluidity of the paste and creating weak zones that reduce cement performance (Kong et al. “Influence of Nano-Silica Agglomeration on Microstructure and Properties of the Hardened Cement-Based Materials,” Constr. Build. Mater. 2012, 37, 707-715; Kong et al. “Influence of Nano-Silica Agglomeration on Fresh Properties of Cement Pastes,” Constr. Build. Mater. 2013, 43, 557-562). To overcome this issue, nanosilica powder is usually pre-dispersed in an aqueous solution (e.g., mixing water) using sonication or other physical and chemical dispersion methods before being added to cementitious materials (Quercia et al. “SCC Modification by Use of Amorphous Nano-Silica,” Cem. Concr. Compos. 2014, 45, 69-81; Elkady et al. “Effect of Nano Silica De-Agglomeration, and Methods of Adding Super-Plasticizer on the Compressive Strength, and Workability of Nano Silica Concrete,” Civ. Environ. Res. 2013; Ghafoori et al. “Influence of Dispersion Methods on Sulfate Resistance of Nanosilica-Contained Mortars,” J. Mater. Civ. Eng. 2017, 29 (7), 04017038). Alternatively, colloidal nanosilica particles can be used directly with cement because negatively charged nanosilica particles are monodispersed owing to their silanol surface functional group (Lowe et al. “Acid-Base Dissociation Mechanisms and Energetics at the Silica-Water Interface: An Activationless Process,” J. Colloid Interface Sci. 2015, 451, 231-244). However, the high calcium concentration and alkaline environment in the cement solution can cause the formation of large agglomerates of nanosilica particles (Andersson et al. “Chemical Composition of Cement Pore Solutions,” Cem. Concr. Res. 1989, 19 (3), 327-332). The divalent calcium cation can act as an interparticle bridge between the nanoparticles (Iler. “Coagulation of Colloidal Silica by Calcium Ions, Mechanism, and Effect of Particle Size,” J. Colloid Interface Sci. 1975, 53 (3), 476-488), and as the pH of the solution increases, nanosilica particles become more negatively charged (Kim et al. “Surface Treatment of Silica Nanoparticles for Stable and Charge-Controlled Colloidal Silica,” Int. J. Nanomedicine 2014, 9 (Suppl 2), 29-40), and the agglomeration becomes more pronounced due to increased electrostatic attraction. Therefore, previous studies have shown that there is an optimum amount of nanosilica particles that can be added beyond which further addition hinders cement strength development (Nili et al. “Investigating the Effect of the Cement Paste and Transition Zone on Strength Development of Concrete Containing Nanosilica and Silica Fume,” Mater. Des. 2015, 75, 174-183; Haruchansapong et al. “Effect of the Particle Size of Nanosilica on the Compressive Strength and the Optimum Replacement Content of Cement Mortar Containing Nano-SiO₂,” Constr. Build. Mater. 2014, 50, 471-477; Saleh et al. “Characterization of Nano-Silica Prepared from Local Silica Sand and Its Application in Cement Mortar Using Optimization Technique,” Adv. Powder Technol. 2015, 26 (4), 1123-1133). Therefore, the agglomeration of nanosilica particles in the cement solution poses a significant limitation to their applicability.

The present disclosure addresses limitations of the present cement industry and provides novel methods for producing cementitious materials from low-cost limestone fillers.

### SUMMARY

Disclosed herein is a new method to produce cementitious materials from low-cost inert fillers and using the cementitious materials as supplementary cementitious material (SCM) in the fabrication of concrete. The method involves coating filler particles (e.g., limestone particles) with fine pozzolanic particles (e.g., nanosilica particles). The resulting product comprises composite particles having inert cores and reactive surfaces. In one version of the method, the coating can be achieved through a simple wet coating method in which limestone and colloidal silica particles are added to a calcium salt solution. The calcium concentration and pH of the solution are adjusted to create opposite surface charges on the two types of materials. The electrostatic impulse causes the colloidal particles to adhere to the surface of the limestone particles. The composite particles are then simply filtered from the reaction solvent. When introduced into a cementitious environment, the reactive coating is converted to a binder (e.g., calcium-silicate-hydrate) through pozzolanic or similar reactions, cementing the filler particles together.

The coated limestone particles can be used as a partial cement replacement in traditional Portland cement concrete or the main cementation agent in more advanced cement systems. High percentages of cement (e.g., up to 50 wt. %) can be replaced with the coated limestone fillers with minimal performance loss. Coating colloidal silica onto limestone fillers overcomes the agglomeration issue because the limestone particles are used as the carrier to introduce colloidal silica into the cement mixture. This effectively distributes the colloidal silica more evenly through the mix, thereby minimizing agglomeration. Additionally, this new coating method may optionally be combined with carbon mineralization techniques to produce carbon-negative cementitious materials.

Thus, disclosed and claimed herein is a method of making concrete, the method comprising mixing one or more cementitious materials with an activator in amounts and for a time effective to form the concrete, wherein the one or more cementitious materials comprise composite particles with an inert core and a reactive surface.

The inert core of the composite particles preferably comprises limestone particles. Other types of rock may also be used, such as breccia, chert, claystone, diatomite, dolomite, rock gypsum, sandstone, shale, siltstone, travertine, etc. For purpose of brevity only, the following description will refer to the core of the particle as being limestone. The limestone particles can be produced from a carbon mineralization process.

The reactive surface of the composite particles comprises pozzolanic particles. Preferably, the pozzolanic particles are fine pozzolanic particles, such as nanosilica particles.

In some versions of the method, the one or more cementitious materials comprise up to 50 wt. % of the composite particles. While making the concrete, the reactive surface of the composite particles is converted to a binder to cement the composite particles together through pozzolanic reactions or similar reactions.

The composite particles are made by coating the inert core with the reactive surface in a solution. In one version of the method, the solution is a calcium salt solution having a calcium concentration and pH wherein the inert core and the reactive surface possess opposite surface charges. This causes the reactive surface materials to be adhered to the core material via electrostatic interactions. The method further comprises separating the composite particles from the solution after the coating is completed.

Also disclosed herein is a method of making concrete, the method comprising mixing one or more cementitious materials with an activator in amounts and for a time effective to form the concrete, wherein the one or more cementitious materials comprise composite particles comprising an inert core comprising non-pyro processed limestone and a reactive surface comprising nanosilica particles. The composite particles are made by coating the inert core with the reactive surface in a solution. The solution may be a calcium salt solution, and the calcium salt solution has a calcium concentration and pH wherein the limestone of inert core and the nanosilica particles of the reactive surface possess opposite surface charges.

Also disclosed herein is a composition of matter comprising: an inert core comprising non-pyro processed limestone and a reactive surface comprising nanosilica particles.

The objects and advantages of the disclosure will appear more fully from the following detailed description of the preferred embodiment of the disclosure made in conjunction with the accompanying drawings.

### BRIEF DESCRIPTION OF THE DRAWINGS

FIG. 1. Representative SEM images of the composite cementitious particles made by coating ground limestone with colloidal nanosilica. Panels (a) & (b) show morphology of limestone coated with NS90 nanosilica (loading content of 28% by weight of dry limestone). Panels (c) & (d) show morphology of limestone coated with NS300 nanosilica (loading content of 14% by weight of dry limestone).

FIG. 2. Particle size distributions of two types of nanosilica (NS300 and NS90), limestone and cement.

FIG. 3. HRWR dosage required for cement paste blends using nanosilica to achieve comparable workability. Columns from left to right for NS300: NS300-1.4, NS300-1.4 (coated), NS300-2.8, and NS300-2.8 (coated). Columns from left to right for NS90: NS90-1.4, NS90-1.4 (coated), NS90-2.8, NS90-2.8 (coated), NS90-5.6, and NS90-5.6 (coated).

FIG. 4. The normalized compressive strength for cement paste mixtures at 3, 7, and 28 days. Columns from left to right for each hydration age: Ref-LS-0, Ref-LS-20, NS300-1.4, NS300-1.4 (coated), NS300-2.8, NS300-2.8 (coated), NS90-1.4, NS90-1.4 (coated), NS90-2.8, NS90-2.8 (coated), NS90-5.6, and NS90-5.6 (coated).

FIG. 5. The normalized Ca(OH)₂ content of two control mixtures and mixtures prepared with 2.8 wt. % nanosilica at 3, 7, and 28 days.

FIG. 6. Pore size distribution (rectangle symbol) and cumulative pore volume (circle symbol) of two control mixtures and mixtures containing 2.8 wt. % nanosilica at 28 days.

### DETAILED DESCRIPTION

Numerical ranges as used herein are intended to include every number and subset of numbers contained within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9, and so forth.

All references to singular characteristics or limitations shall include the corresponding plural characteristic or limitation, and vice versa, unless otherwise specified or clearly implied to the contrary by the context in which the reference is made. That is, unless specifically stated to the contrary, “a” and “an” mean “one or more.” The phrase “one or more” is readily understood by one of skill in the art, particularly when read in context of its usage. For example, “one or more” substituents on a phenyl ring designates one to five substituents.

The elements and method steps described herein can be used in any combination whether explicitly described or not.

All combinations of method steps as used herein can be performed in any order, unless otherwise specified or clearly implied to the contrary by the context in which the referenced combination is made.

The methods disclosed herein can comprise, consist of, or consist essentially of the essential elements and limitations of the method as described herein, as well as any additional or optional ingredients, components, or limitations described herein or otherwise useful in the art. The disclosure provided herein suitably may be practiced in the absence of any element which is not specifically disclosed herein.

It is understood that the invention is not confined to the particular construction and arrangement of parts herein illustrated and described, but embraces such modified forms thereof as come within the scope of the claims.

As used herein, “pozzolanic particles” or “pozzolanic materials” refer to natural or synthetic siliceous or siliceous and aluminous materials that react chemically with calcium hydroxide in water to form compounds such as calcium-silicate-hydrate (C—S—H) with cementitious properties. Non-limiting examples of pozzolanic materials include silica nanoparticles (e.g., colloidal nanosilica), fly ash, slag, silica fume, calcined clay (e.g., metakaolin), and calcined shale. “Fine pozzolanic particles” refers to finely divided pozzolanic materials. Fine pozzolanic particles typically have a high surface area and reactivity due to their small size and amorphous structure.

Unless explicitly specified to the contrary, the term “solution” is used herein to refer to an aqueous solution, wherein “aqueous” refers to containing water as a solvent or medium. In any solution herein, the solution preferably comprises water in an amount of at least 50% v/v, such as at least 55% v/v, at least 60% v/v, at least 65% v/v, at least 70% v/v, at least 75% v/v, at least 80% v/v, at least 85% v/v, at least 90% v/v, at least 95% v/v, or at least 99% v/v. For the avoidance of doubt, such volumes of the solutions account for only the volumes of the liquid portions of the solutions (including any molecules dissolved therein) and do not account for the volumes of any solids contacted, suspended, or dispersed therein.

Provided herein are methods of making concrete, the method comprising mixing one or more cementitious materials with an activator in amounts and for a time effective to form the concrete. The one or more cementitious materials comprise composite particles with an inert core and a reactive surface.

Compared to the traditional cementation approach that has relied on bulk reactive particles, using particles whose surfaces have been modified to be reactive represents a fundamental advancement in material utilization. Poor material utilization has long been recognized in cement and concrete. In fact, it is well known that, for concrete with a given cement paste volume, the less the cement is reacted, the higher the performance the concrete will have. This is because that the residual unreacted cement particles result in a dense particle packing structure, leaving less void space that needs to be filled by the cementitious binder.

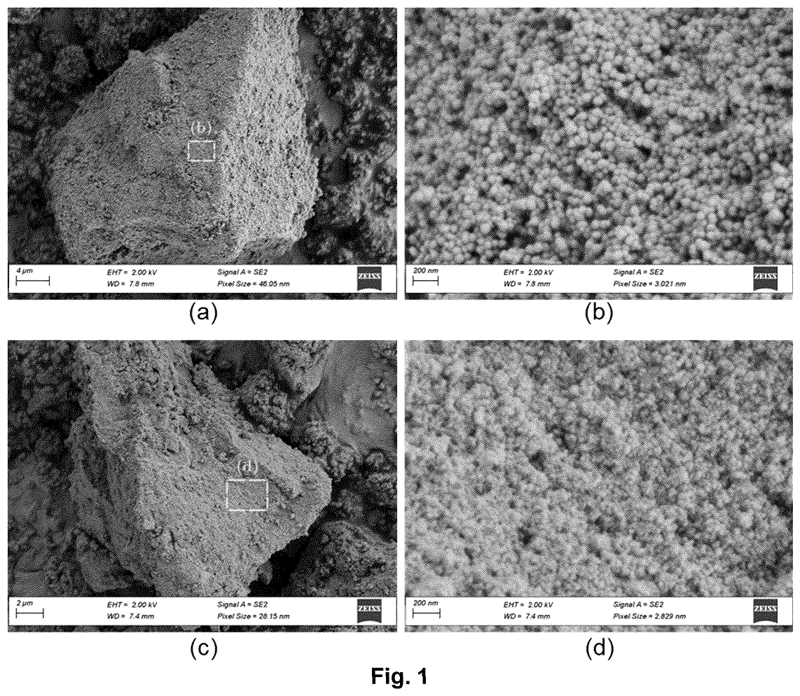

In one version of the method, the cementitious materials are produced from low-cost limestone fillers without pyro-processing. The method involves coating limestone particles with fine pozzolanic particles (e.g., nanosilica), producing composite particles with inert cores and reactive surfaces (FIG. 1). When introduced into a cementitious environment, the reactive coating is converted to a binder (e.g., calcium-silicate-hydrate) through pozzolanic or similar reactions, cementing the filler particles together. The coated limestone particles can be used as a partial cement replacement in traditional Portland cement concrete or as the main cementation agent in more advanced cement systems.

The coating can be achieved by any methods known in the art or developed in the future, using any suitable forms of limestone particles and nanosilica. As an example, the coating illustrated in FIG. 1 was achieved through a simple wet coating method. Limestone and colloidal silica particles were added into a calcium salt solution (in the case of FIG. 1, CaCl₂)) where the calcium concentration and pH were adjusted to create opposite surface charges on the two types of particles. The coating is spontaneous and can be reliably achieved after 10-20 minutes of stirring. Different coating contents can be obtained by adjusting the amount of colloidal silica added into the solution. After the coating step, the particles were separated from the solution via filtration and stored for later use.

In an aqueous solution, the van der Waals and electrostatic interactions are the governing mechanisms that control the coating process. The electrostatic interactions are directly related to the surface charge of the particles. Both limestone and colloidal silica particles have strong surface charge in an aqueous solution. Like most metal oxides, silica (SiO₂) particles are hydrolyzed on their exterior surface, forming surface silanol groups (Si—OH) in water. The solution pH determines whether the surface silanol groups are protonated or deprotonated, which changes the surface charge of colloidal silica. The potential-determining ions for limestone (CaCO₃) are Ca²⁺ and CO₃²⁻. Adsorption of these ions onto mineral surfaces depends on their concentration in the solution, which in turn controls the surface charge of limestone particles. Using calcium salt solution such as CaCl₂) as a calcium source decreases the acidity of the solution, making colloidal silica more negatively charged. This increases the electrostatic attraction between limestone and colloidal silica, leading to a higher maximum coating efficiency.

Both limestone fillers and colloidal silica are commercially available. The two materials have some uses in cement and concrete. Ground limestone is routinely added to cement as a filler, but only at a ratio no more than about 15% by weight. Colloidal silica is largely considered a specialty product for surface finishing or producing high-performance concrete. There are recent applications of colloidal silica as high-performance supplementary cementitious materials (SCM) due to the anticipated shortage of traditional SCM. However, the utilization of colloidal silica has been limited due to its high tendency to agglomerate in cementitious environments. The agglomeration not only substantially reduces their performance, but also reduces the mixture's workability. Currently, to compensate for the workability loss, high-cost specialty chemicals like high-range water reducers (HRWRs) are used, which can be a major cost for concrete designed for high-performance applications.

Coating colloidal silica onto limestone fillers overcomes the agglomeration issue. Here, limestone particles are used as the carrier to introduce colloidal silica into the cement mixture. Because the coating is stable, simply mixing the coated limestone particles within the cement and concrete mixture will disperse the colloidal silica. This substantially improves the mixture workability and reduces the required HRWR dosage. Our experiments show that, for high-surface area colloidal silica particles (300 m²/g), coating reduces the required HRWR dosage for maintaining workability by 50%. Furthermore, because the reaction occurs directly on the filler particle surfaces, particle-particle bonding as well as void filling efficiency are much enhanced. Experimental results show that coating can reduce the internal pore volume in the cement paste by one order of magnitude. A less porous cement paste is highly desired because it can mitigate a number of common concrete durability issues such as rebar corrosion and the ingression of aggressive ions.

Another benefit of the technology is that it offers a pathway to substantially reduce the carbon emissions associated with cement and concrete. Because ground limestone has much lower embodied carbon emissions compared to portland cement, replacing cement with limestone is often discussed as a sustainable practice by the cement industry. However, when neat limestone is introduced into cement at large dosages, performance loss is expected due to the dilution effect, e.g., 20 wt. % limestone leads to 20% loss in compressive strength. So far, the replacement ratio in commercial portland cement is limited to 15 wt. % in the U.S. With coated limestone particles, however, the lost strength can be fully recovered by the colloidal silica coating (e.g., at 7-28 wt. % coating, depending on the size of the colloidal silica particles). As such, high percentages of cement can be replaced with limestone fillers through coating. For example, up to 50 wt. % of cement can be replaced with the coated limestone fillers, at which level, the carbon intensity would be reduced up to 50%. Alternatively, at least 55 wt. %, at least 60 wt. %, at least 65 wt. %, at least 70 wt. %, at least 75 wt. %, at least 80 wt. %, at least 85 wt. %, at least 90 wt. %, at least 95 wt. %, or at least 98 wt. % cement can be replaced with the coated limestone fillers.

Furthermore, carbon negative limestone particles can be produced from a range of carbon mineralization processes, sequestering up to 44% CO₂ by weight. Combining carbon mineralization with the coating method can produce carbon-negative cementitious materials that can be used to eliminate the emission intensity of concrete and potentially make it carbon negative.

Overall, the approach overcomes limitations of the present Portland Limestone Cement (PLC, Type IL), and can potentially increase the replacement ratio of cement with the coated limestone fillers up to 50 wt. %. When compared to the other common method to reduce cement usage, i.e., the utilization of SCM, the performance of the coated limestone is much higher and more consistent. Most SCM in the current market are waste materials recycled with minimal processing. One of the main concerns from the industry has been the variability in these materials' performance. In comparison, the performance of the coated limestone can be controlled to a high degree. The limestone particle size distribution, colloidal silica particle size, and coating content can all be controlled precisely during production. Simultaneously, the overall cost is much lower than synthesized SCM such as colloidal silica because the bulk of the material is simply limestone.

### EXAMPLES

This Example investigates the effectiveness of coating nanosilica particles on the limestone surface to improve their dispersion and enhance the mechanical performance of cement paste. nanosilica particles tend to agglomerate in the cement system, limiting their dispersion and potential contribution to strength development. Coating nanosilica particles on the limestone surface through the wet coating method could alleviate this problem. The effect of the nanosilica-coated limestone composite on the microscopic and macroscopic characteristics of cement paste samples were investigated using various test methods. The results were compared with those obtained for samples containing limestone powder and nanosilica added separately. Results show that coating nanosilica particles on the limestone surface reduces the required amount of HRWR, decreases CH content, refines pore structures and improves compressive strength compared to separately added colloidal nanosilica in the cement paste samples. These findings suggest that the nanosilica-coated limestone composite can be used to develop sustainable and high-performance cement-based materials.

### Materials and Methods

### Materials

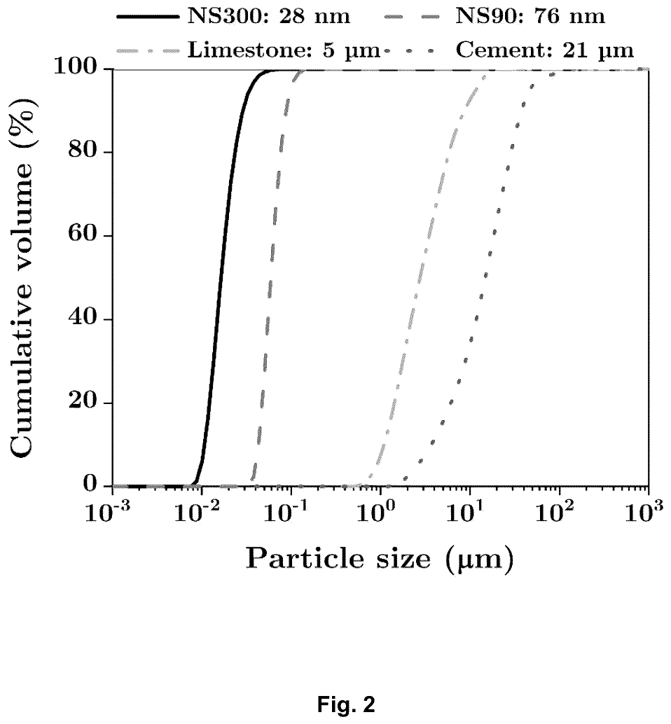

The materials used herein comprised of Type IL cement, ground natural limestone, colloidal nanosilica, polycarboxylate-based HRWR, calcium nitrate tetrahydrate (Ca(NO₃)₂·4 H₂O) powder (ACS analytical grade), and nitric acid (HNO₃) solution. The ground natural limestone had an average particle size of 4.8 μm. Two types of colloidal nanosilica were utilized: one with a surface area of 90 m²/g (NS90) and the other with a surface area of 300 m²/g (NS300). Particle size distributions of the cement, limestone, and nanosilica particles are presented in FIG. 2. The polycarboxylate-based HRWR was used to improve the workability of the cement paste mixtures. The nitric acid solution was further diluted with deionized (DI) water (ASTM type II) to different concentrations.

### Preparation of Nanosilica-Coated Limestone Composites

A previously developed wet coating method was applied to prepare nanosilica-coated limestone particles. (See Liu et al. “Wet coating of calcite with silica nanoparticles in CO₂ environment,” J. Coat. Technol. Res. 2024, 21(1):423-434.) Briefly, limestone particles and nanosilica particles are added to an aqueous solution in which the two types of particles possess opposite surface charges. Coating is achieved spontaneously due to the electrostatic attraction as well as van der Waals force between the two types of particles. The coating performance and stability have been reported in Liu et al. (2024).

Here, to prepare limestone coated with NS90, 100 g of limestone powder was added to 200 mL of 18 mM Ca(NO₃)₂ solution in a beaker. While the mixture was stirred with a magnetic stirrer at 800 rpm, the NS90 colloidal nanosilica was added, and the coating process was allowed to proceed for an additional 10 min. The resulting mixture was vacuum-filtered, and the collected wet powder was redispersed in 100 mL DI water in a glass container and sealed with Parafilm. Coated limestone particles with three different nanosilica loading levels, 7%, 14%, and 28% by weight of dry limestone powder, were prepared by varying the amount of colloidal nanosilica added into the coating solution.

For NS300, a slightly different procedure was followed due to its strong agglomeration tendency even at low calcium ion concentrations ([Ca²⁺]), resulted from its significantly larger surface area. The pH of the coating solution was decreased to reduce the negative charge of nanosilica particles, thereby improving the colloidal stability in the presence of Ca²⁺. The coating procedure was initiated by adding NS300 colloidal solution to 200 mL DI water and stirring at 800 rpm using a magnetic stirrer. Next, 1 M HNO₃ solution was added to decrease the solution pH to between 7.5 and 8.0. Calcium nitrate tetrahydrate powder was added to achieve a [Ca²⁺] of 40 mM. The limestone powder was then added to the solution, and the rest of the procedure followed the same steps as with NS90. Coated limestone particles with two different nanosilica loading levels, 7% and 14% by weight of dry limestone powder, were prepared.

All loading levels were confirmed using thermogravimetric analysis. FIG. 1 displays the Scanning Electron Microscopy (SEM) images of the coated limestones with the highest loading level for the two types of nanosilica. For both NS90 and NS300, images clearly show an even distribution of nanosilica particles on the surface of the limestone.

### Preparation of Cement Pastes

Cement pastes were prepared according to the mixture designs in Table 1. The quantity of limestone was expressed as a weight percentage (wt. %) of the total binder materials. The reference sample, Ref-LS-0, was a plain cement mixture, and the Ref-LS-20 sample contained 20 wt. % limestone. The rest of cement paste mixtures were divided into two sets. The first set contained 20 wt. % limestone and varying amounts of NS300 nanosilica (1.4% and 2.8% by the total weight of binder) and NS90 nanosilica (1.4%, 2.8%, and 5.6% by the total weight of binder). In the first set, nanosilica was directly added to the mixture in colloidal form. The second set of mixtures had the same types and amounts of nanosilica, but nanoparticles were coated on the limestone surface. All mixtures had a water-to-binder weight (w/b) ratio of 0.4. To ensure similar workability, the amount of HRWR for each mixture was adjusted based on the mini-slump test result. A target flow spread diameter of 75±5 mm was set for all mixtures.

TABLE 1
Mix proportions of the cement paste mixtures tested in this Example.

| | | | | SiO₂ | | | |
|---|---|---|---|---|---|---|---|
| | | | | nanoparticles | | | |
| | | | | (in colloidal | DI | | Mini |
| | | Cement | Limestone | form)* | water | HRWR | slump |
| Mix No. | Mix ID | (g) | (g) | (g) | (g) | (g) | (mm) |
| 1 | Ref-LS-0 | 280.00 | 0.00 | 0 | 112 | 0.36 | 75 |
| 2 | Ref-LS-20 | 224.00 | 56.00 | 0 | 112 | 0.52 | 76 |
| 3 | NS300-1.4 | 220.08 | 56.00 | 13.06 | 102.86 | 2.3 | 75 |
| | | | | (NS300) | | | |
| 4 | NS300-1.4 | 220.08 | 59.92 | 0 | 112 | 1.16 | 76 |
| | (coated) | | (coated) | | | | |
| 5 | NS300-2.8 | 216.16 | 56.00 | 26.14 | 93.7 | 4.22 | 76 |
| | | | | (NS300) | | | |
| 6 | NS300-2.8 | 216.16 | 63.84 | 0 | 112 | 2.12 | 75 |
| | (coated) | | (coated) | | | | |
| 7 | NS90-1.4 | 220.08 | 56.00 | 7.84 | 104.16 | 0.72 | 76 |
| | | | | (NS90) | | | |
| 8 | NS90-1.4 | 220.08 | 59.92 | 0 | 112 | 0.68 | 77 |
| | (coated) | | (coated) | | | | |
| 9 | NS90-2.8 | 216.16 | 56.00 | 15.68 | 104.16 | 0.94 | 76 |
| | | | | (NS90) | | | |
| 10 | NS90-2.8 | 216.16 | 63.84 | 0 | 112 | 0.88 | 75 |
| | (coated) | | (coated) | | | | |
| 11 | NS90-5.6 | 208.32 | 56.00 | 31.36 | 96.32 | 1.54 | 75 |
| | | | | (NS90) | | | |
| 12 | NS90-5.6 | 208.32 | 71.68 | 0 | 112 | 1.4 | 76 |
| | (coated) | | (coated) | | | | |

To prepare the mixture, the solution mixing DI water, HRWR, colloidal nanosilica or coated limestone suspension, was first homogenized manually with a glass rod. Next, uncoated limestone powder (when applicable), was added to the solution and manually mixed for 30 s. Cement was then added, and the mixture was manually mixed for another 30 s. It is worth mentioning that the weight of coated limestone mentioned in Table 1 is in dry powder form, while nanosilica-coated limestone was kept in DI water to enhance homogeneity. The moisture content of the nanosilica-coated limestone was determined and accounted for during mixture preparation. Once all ingredients were added, the mixture was mixed for 4 min at 450 rpm. The resulting fresh paste was cast into cylindrical molds (inner diameter=21.5 mm, height=55 mm), sealed, and cured in an environmental chamber (23.5±0.5° C., 50% relative humidity).

### Testing Methods

### Compressive Strength Measurement

Compressive strength was measured using uniaxial compression tests at 3, 7, and 28 days of curing. Cylindrical specimens with a height-to-diameter ratio of 2 were prepared by cutting the samples to a height of 43 mm using a low-speed saw. The diameter of the cylindrical specimens was measured to calculate the surface area. The samples were then tested using a universal testing system (Model 43, MTS Criterion) with a 50 kN load cell at a loading rate of 0.2 mm/min. At least three specimens were tested for each mixture.

### Thermogravimetric Analysis (TGA)

Two control samples (Ref-LS-0 and Ref-LS-20) and six samples containing 2.8 wt. % nanosilica particles, either added in colloidal form or coated onto limestone particles, were prepared and tested. The calcium hydroxide content in these samples was evaluated at 3 days, 7 days, and 28 days of curing using TGA, which provides an indication of the performance of nanosilica in terms of pozzolanic reaction and hydration alteration.

At each specific age, a cylindrical cement paste sample was crushed, and fragments were lightly ground using an agate mortar and pestle, using isopropanol as a grinding aid. The ground sample was then sieved through a 200-mesh sieve (74 μm), and the collected powder was immediately used for TGA. Approximately 10-20 mg of the powder was transferred into a platinum pan and analyzed using a thermogravimetric analyzer. The weight loss due to thermal decomposition was recorded over a temperature range of 20° C. to 1000° C. at a constant heating rate of 10° C./min under a nitrogen (N2) atmosphere.

The mass losses due to the decomposition of calcium hydroxide (Ca(OH)₂, or CH) and calcium carbonate (CaCO₃) were determined using a modified TGA interpretation method (Kim et al. “Effects of Sample Preparation and Interpretation of Thermogravimetric Curves on Calcium Hydroxide in Hydrated Pastes and Mortars,” Transp. Res. Rec. 2012, 2290 (1), 10-18). Equation 1 was used to calculate the Ca(OH)₂ content percentage in the sample:

$$CH ( \% ) = \frac{{m}_{{Ca ( OH )}_{2}}}{{m}_{Cement}} \times 100 \qquad ( Eq . 1 )$$

where m_{Cement} and m_{Ca(OH)}_{₂} represent the masses of cement and CH in the sample, respectively. CH (%) is the percentage of total Ca(OH)₂ content per gram of cement.

### Pore Size Distribution

To investigate the impact of nanosilica-coated limestone composite on the pore structure of cement-based samples, nitrogen adsorption/desorption (NAD) experiments were conducted using a gas sorption analyzer over a range of relative pressures (p/po) from 0.400 to 0.967 on the cement paste samples. The pore size distribution was determined using the Barrett-Joyner-Halenda (BJH) method. Before the NAD experiment, the hydration of the cement paste samples was terminated using the solvent exchange technique. Isopropanol was used to displace the pore water, as it causes less damage to the pore structure and better preserve fine pores (Zhang et al. “Comparison of Methods for Arresting Hydration of Cement,” Cem. Concr. Res. 2011, 41 (10), 1024-1036; Zhang et al. “Evaluation of Drying Methods by Nitrogen Adsorption,” Cem. Concr. Res. 2019, 120, 13-26; Yang, et al. “Multiscale Pore Structure Determination of Cement Paste via Simulation and Experiment: The Case of Alkali-Activated Metakaolin,” Cem. Concr. Res. 2020, 137, 106212). At the age of 28 days, the cylindrical cement paste samples were demolded and sliced into 1.5 mm thick disks using a low-speed saw. The disks, each weighing approximately 1-2 g, were then immersed in 200 mL isopropanol for three days, with the solvent renewed at 1 h and 1 day after submersion. After solvent exchange for three days, the disks were removed and placed in a vacuum oven at 40° C. for three days to remove any residual isopropanol.

For the NAD experiment, approximately 0.5 g of fragments were first degassed at 40° C. for one day, and then the NAD test was performed at 77 K. (See Aligizaki et al. Pore Structure of Cement-Based Materials: Testing, Interpretation and Requirements; CRC Press, 2005.) The pore size distribution was calculated based on the pore condensation principle over a range of p/po from 0.400 to 0.967 using the desorption isotherm and the Barrett-Joyner-Halenda (BJH) method. (See Barrett et al. “The Determination of Pore Volume and Area Distributions in Porous Substances. I. Computations from Nitrogen Isotherms,” J. Am. Chem. Soc. 1951, 73 (1), 373-380.)

### Particle Size Measurements

Particle size distributions of limestone and cement powders were measured using a Laser Diffraction Particle Size Analyzer. The particle size distribution of nanosilica particles was obtained using the dynamic light scattering technique.

### Results and Discussion

### HRWR Dosage to Maintain Workability

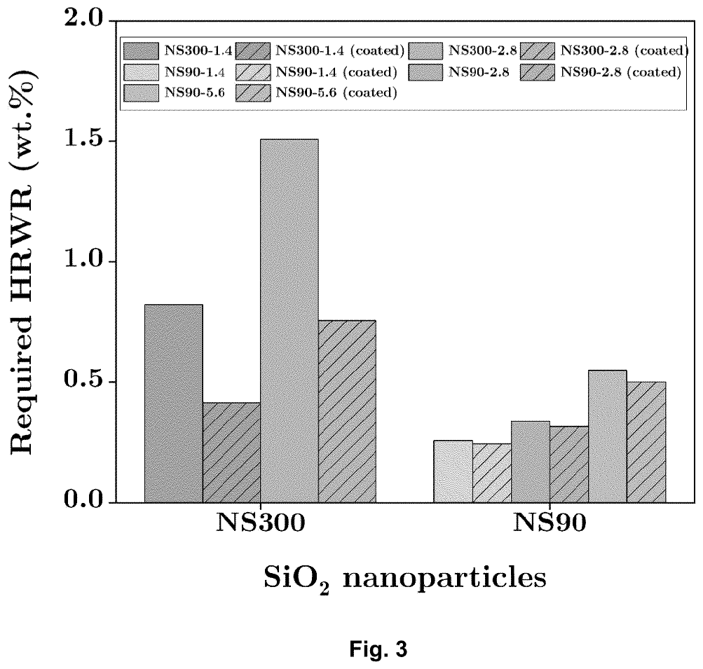

The appropriate HRWR dosage required for cement paste mixtures with and without nanosilica to achieve the target flow spread (75±5 mm) is presented in FIG. 3. The required HRWR dosage increased with the dosage of both nanosilica (NS90 and NS300). NS300, which had a higher specific surface area, required a significantly higher amount of HRWR than NS90.

Compared to the cement-based systems with uncoated nanosilica (where nanosilica and limestone powder were added separately), loading nanosilica on limestone particles reduced the HRWR dosage. This effect was particularly pronounced with NS300, leading to approximately a 50% reduction in HRWR demand. For NS90, the reduction ranged from 5% to 10% depending on the amount of nanosilica.

The HRWR used in this Example is based on polycarboxylic ether (PCE) polymers. PCE-based HRWRs are widely used in the cement industry and is generally very effective in dispersing cement particles and improve the workability of cement paste (Uchikawa et al. “Influence of Kind and Added Timing of Organic Admixture on the Composition, Structure and Property of Fresh Cement Paste,” Cem. Concr. Res. 1995, 25 (2), 353-364; Yamada et al. “Effects of the Chemical Structure on the Properties of Polycarboxylate-Type Superplasticizer,” Cem. Concr. Res. 2000, 30 (2), 197-207). When nanosilica is added to cement paste, severe agglomerations tend to occur due to the increased negative charge of these nanoparticles in the high-pH cement solution, as well as their sensitivity to the presence of salts, particularly Ca²⁺ ions, that can act as cross-linking agents between SiO₂ surfaces (Iler. “Coagulation of Colloidal Silica by Calcium Ions, Mechanism, and Effect of Particle Size,” J. Colloid Interface Sci. 1975, 53 (3), 476-488; Kim et al. “Surface Treatment of Silica Nanoparticles for Stable and Charge-Controlled Colloidal Silica,” Int. J. Nanomedicine 2014, 9 (Suppl 2), 29-40; Barisik et al. “Size Dependent Surface Charge Properties of Silica Nanoparticles,” J. Phys. Chem. C 2014, 118 (4), 1836-1842). During agglomeration, considerable amounts of water can be entrapped within the agglomerates, reducing the availability of free water and decreasing the fluidity of the cement paste (Madani et al. “The Pozzolanic Reactivity of Monodispersed Nanosilica Hydrosols and Their Influence on the Hydration Characteristics of Portland Cement,” Cem. Concr. Res. 2012, 42 (12), 1563-1570; Kontolcontos et al. “Influence of Colloidal Nanosilica on Ultrafine Cement Hydration: Physicochemical and Microstructural Characterization,” Constr. Build. Mater. 2012, 35, 347-360). Consequently, higher HRWR dosages are needed to maintain the same fluidity. In particular, the larger the specific surface area—such as in the case of NS300 compared to NS90—the more serve agglomeration the nanoparticles will exhibit, which in turn requires higher dosage of HRWR.

These negatively charged polymers are adsorbed on the surface of cement particles, resulting in electrostatic and steric repulsions between the particles. This hinders particle agglomeration, thus improving the flowability of the paste and reducing its yield stress. Numerous studies have shown that the use of WR can significantly improve the mechanical properties of concrete and enhance its durability by reducing water demand. See Ferrari et al. “Interaction of Cement Model Systems with Superplasticizers Investigated by Atomic Force Microscopy, Zeta Potential, and Adsorption Measurements,” J. Colloid Interface Sci. 2010, 347 (1), 15-24.

The addition of nanosilica particles to cement-based systems can enhance their performance and durability, but they are prone to agglomeration, which can compromise their effectiveness (Senff et al. “Effect of Nano-Silica on Rheology and Fresh Properties of Cement Pastes and Mortars,” Constr. Build. Mater. 2009, 23 (7), 2487-2491; Oltulu et al. “Effect of Nano-SiO₂, Nano-Al₂O₃ and Nano-Fe₂O₃ Powders on Compressive Strengths and Capillary Water Absorption of Cement Mortar Containing Fly Ash: A Comparative Study,” Energy Build. 2013, 58, 292-301; Reches et al. “Agglomeration and Reactivity of Nanoparticles of SiO₂, TiO₂, Al₂O₃, Fe₂O₃, and Clays in Cement Pastes and Effects on Compressive Strength at Ambient and Elevated Temperatures,” Constr. Build. Mater. 2018, 167, 860-873). Studies have shown that nanosilica particles tend to agglomerate in cement-based media due to the increased negative charge of the particles in the cement solution (high alkalinity), as well as their sensitivity to the presence of salts, particularly Ca²⁺ ions, which acts as cross-linking agents between nanosilica particles (Iler. “Coagulation of Colloidal Silica by Calcium Ions, Mechanism, and Effect of Particle Size,” J. Colloid Interface Sci. 1975, 53 (3), 476-488; Kim et al. “Surface Treatment of Silica Nanoparticles for Stable and Charge-Controlled Colloidal Silica,” Int. J. Nanomedicine 2014, 9 (Suppl 2), 29-40; Barisik et al. “Size Dependent Surface Charge Properties of Silica Nanoparticles,” J. Phys. Chem. C 2014, 118 (4), 1836-1842). This agglomeration results in the formation of microscale clusters, which prevent nanosilica particles from being well dispersed in the cement-based matrix, leading to weak zones and reduced performance (Kong et al. “Influence of Nano-Silica Agglomeration on Microstructure and Properties of the Hardened Cement-Based Materials,” Constr. Build. Mater. 2012, 37, 707-715; Oltulu et al. “Effect of Nano-SiO₂, Nano-Al₂O₃ and Nano-Fe₂O₃ Powders on Compressive Strengths and Capillary Water Absorption of Cement Mortar Containing Fly Ash: A Comparative Study,” Energy Build. 2013, 58, 292-301; Reches et al. “Agglomeration and Reactivity of Nanoparticles of SiO₂, TiO₂, Al₂O₃, Fe₂O₃, and Clays in Cement Pastes and Effects on Compressive Strength at Ambient and Elevated Temperatures,” Constr. Build. Mater. 2018, 167, 860-873; Sargam et al. “Influence of Dispersants and Dispersion on Properties of Nanosilica Modified Cement-Based Materials,” Cem. Concr. Compos. 2021, 118, 103969). Additionally, a considerable amount of water is entrapped within these agglomerates, reducing the amount of free water and decreasing the fluidity of the cement-based materials (Madani et al. “The Pozzolanic Reactivity of Monodispersed Nanosilica Hydrosols and Their Influence on the Hydration Characteristics of Portland Cement,” Cem. Concr. Res. 2012, 42 (12), 1563-1570; Kontolcontos et al. “Influence of Colloidal Nanosilica on Ultrafine Cement Hydration: Physicochemical and Microstructural Characterization,” Constr. Build. Mater. 2012, 35, 347-360). Therefore, addressing the agglomeration issue is crucial to ensure the optimal performance of nanosilica particles in cement-based systems.

To address this issue, HRWR was added to improve the workability of the cement paste. As the amount of nanosilica particles increases, the severity of agglomeration also increases, necessitating a higher amount of HRWR to maintain the same fluidity. In particular, NS300 nanosilica, which had a significantly larger surface area than NS90, exhibited more severe agglomeration in the cement-based matrix, requiring a higher amount of HRWR to achieve comparable workability. Moreover, micron-sized limestone particles can be easily dispersed within the cement-based matrix, so the nanosilica particles coated on the surface of limestone substrate can be more readily dispersed within the cement-based matrix, resulting in their more uniform distribution. Consequently, the amount of HRWR required for the cement-based materials incorporating nanosilica-coated limestone composite is lower than those with nanosilica to achieve similar fluidity. This difference is particularly pronounced for nanosilica with a higher specific surface area (e.g., NS300), where the use of nanosilica-coated limestone composite can reduce the required amount of HRWR by approximately 50%.

Moreover, the reduction in the amount of HRWR required for mixtures with nanosilica coated on the limestone surface could potentially alleviate the negative retarding impact of HRWR on the early stages of cement hydration, as the amount of HRWR is significantly reduced. This is particularly beneficial for large-scale concrete projects where high early strength is critical to the overall performance of the concrete structure.

### Compressive Strength

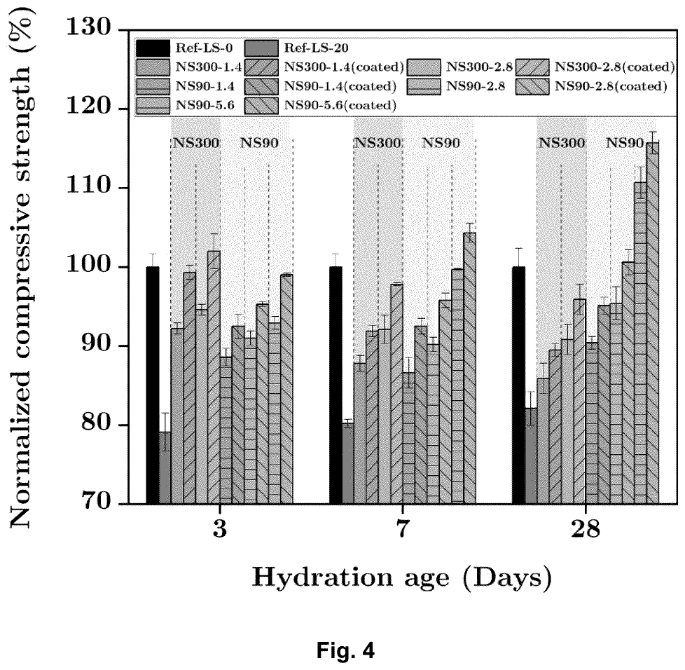

FIG. 4 illustrates the normalized compressive strength of cement paste samples at 3, 7, and 28 days of curing. The results showed that replacing 20 wt. % of cement with limestone powder reduced the compressive strength by approximately 20% at all curing ages. This strength loss was recovered to various degrees through the addition of nanosilica, and this effect was more significant at higher amount of nanosilica regardless of the surface area. In particular, incorporating 5.6 wt. % NS90 coated on limestone particles fully recovered the strength loss caused by the addition of limestone at 3 days. The compressive strength of this mixture at 7 and 28 days even exceeded the neat cement paste (without limestone; Ref-LS-0) by 8% and 15% respectively. The strength improvement effect slowed down with curing time for nanosilica with higher surface area (NS300), while nanosilica with lower surface area (NS90) showed more significant strength improvement at later ages. For the same amount of nanosilica, NS300 resulted in a more significant strength improvement than NS90 during the first 7 days of reaction, while NS90 showed a greater enhancement in compressive strength after 28 days.

In addition, irrespective of specific surface area, cement-based mixtures prepared with the coated nanosilica showed greater compressive strength compared to those prepared with direct addition of nanosilica into the mixture during mixing process at all replacement ratios. For example, for both specific surface areas of nanosilica (NS90 and NS300), cement paste samples prepared with limestone loaded with 1.4 wt. % nanosilica exhibited a greater compressive strength compared to those prepared with the direct addition of 2.8 wt. % nanosilica after 3 days of curing. Although this trend became less pronounced and even reversed at later stages, the samples prepared with coated limestone still had comparable compressive strength.

The results suggest that coating nanosilica particles on the limestone surface significantly improves their dispersion in the cement-based matrix. The improved dispersion showed a noticeable effect on the compressive strength development during early age curing (up to 7 days), so the sample prepared with the limestone particles loaded with 1.4 wt. % nanosilica outperformed the samples prepared with the direct incorporation of 2.8 wt. % nanosilica after 3 days of curing. However, note that the latter contains twice the amount of nanosilica, leading to an increase in the production cost. Additionally, the retarding effect of HRWR is expected to be more prominent in the samples prepared through the direct addition of 2.8 wt. % nanosilica compared to those prepared with 1.4 wt. % coated nanosilica. This is because the former samples used a higher concentration of HRWR, which is likely to have a stronger retarding effect on cement hydration.

As a result, the specimen prepared with the limestone coated with 1.4 wt. % nanosilica showed comparable compressive strength after 7 days and slightly reduced compressive strength after 28 days of curing compared to the specimen prepared with the direct incorporation of 2.8 wt. % nanosilica into the cement paste mixtures. Similar trends were observed for the samples prepared with the coated limestone powder loaded with 2.8 wt. % NS90 and the specimens prepared with the direct addition of 5.6 wt. % NS90, where they showed comparable performance after 3 and 7 days, while the samples prepared with the direct addition of 5.6 wt. % nanosilica showed a higher compressive strength at 28 days.

### Pozzolanic Reactivity of Nanosilica in Cement-Based Mixtures

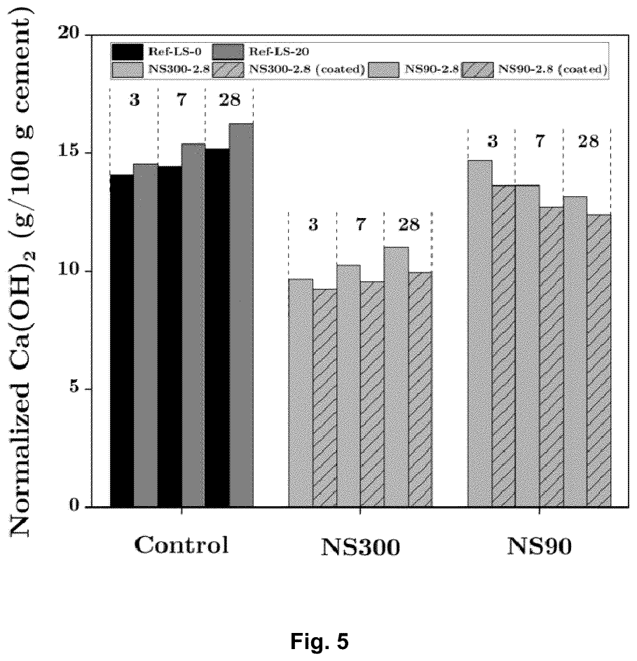

Ca(OH)₂ (CH) is a byproduct of cement hydration and generally considered to have deleterious effects on mechanical performance and durability. A main benefit of introducing nanosilica into the cement-based mixtures is that they can convert CH into C—S—H via pozzolanic reaction. The overall pozzolanic reactivity of nanosilica can be evaluated by measuring the CH content in cement paste samples, as shown in FIG. 5. In this study, the development of CH content per gram of cement was measured using TGA in two control cases (Ref-LS-0 and Ref-LS-20) and in samples prepared with 2.8 wt. % nanosilica (NS90 or NS300).

The CH content in the control cases increased with the hydration time. Replacing 20 wt. % of cement with limestone increased the CH content at 3, 7 and 28 days due to the acceleration in cement hydration through the application of limestone fines. The addition of nanosilica to the cement-based mixtures noticeably reduced the CH content. However, the changes in CH content over time were different between the NS300 and NS90. Cement paste samples prepared with NS300 nanosilica exhibited an increasing CH content with the hydration age, whereas samples prepared with NS90 nanosilica showed a decreasing trend. This can be attributed to the larger specific surface area of NS300 and thus, a higher pozzolanic reactivity was anticipated. Therefore, a more significant reduction in the CH content was observed during very early ages (3 days) in the case of NS300 compared to NS90. However, higher pozzolanic reactivity of NS300 also means a faster consumption of nanosilica particles. NS300 particles consumed more CH, leading to a significantly lower CH content compared to samples incorporating NS90. However, the rapid consumption of NS300 led to a lower amount of NS300 particles available in the cement-based matrix, resulting in lower consumption of CH over time despite its higher pozzolanic reactivity. In contrast, NS90 particles with a lower specific surface area and reactivity consumed less CH, leading to a higher available CH content in the paste samples. However, higher availability of NS90 contributed to more pronounced reduction of the CH content at later curing ages (28 days).

Furthermore, coating limestone particles with nanosilica reduced the CH content in cement paste samples more effectively than when nanosilica was added separately. This finding suggests that coating nanosilica is an efficient method for addressing the agglomeration of nanosilica particles when they are directly incorporated into cement-based mixtures.

### Pore Size Distribution

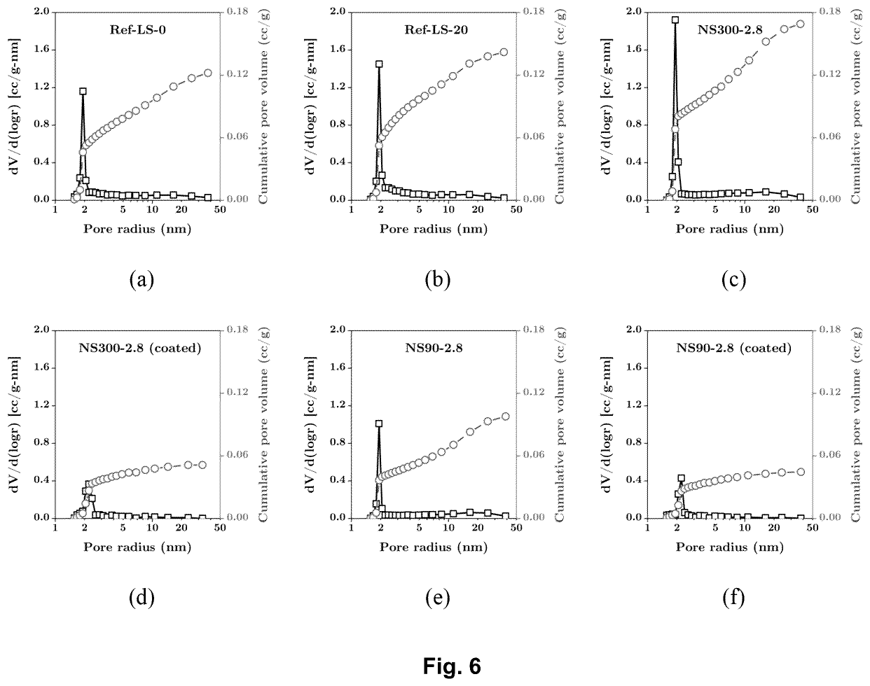

The durability performance of cement-based materials is greatly influenced by their pore system. To study the pore size distribution of cement paste samples after 28 days of curing, desorption curves from NAD tests were analyzed using the Barrett-Joyner-Halenda (BJH) method. The results are shown in FIG. 6. The pore size distribution of the sample Ref-LS-O exhibited a main peak at r=2 nm and a minor peak at r≈16 nm. The main peak represents the interlayer micropores of C—S—H, while the minor peak corresponds to small capillary pores within the mesopore range (2-50 nm, IUPAC). The addition of 20 wt. % limestone moderately increased the intensity of the main peak and the cumulative pore volume from 0.122 (Ref-LS-0) to 0.142 cc/g. At such a high replacement ratio, limestone dilutes the cement content, resulting in a reduced formation of hydration product and higher pore volume.

Compared to the direct addition of nanosilica into the cement-based mixtures, nanosilica coated on the limestone particles significantly reduced the intensity of the main peak. The secondary peak around 16 nm disappeared. The pore volume was reduced to 0.051 and 0.045 cc/ml for the mixtures containing NS300 and NS90, respectively. These observations suggest that coating nanosilica on limestone particles effectively improves their dispersion in the cement matrix, leading to a reduction in the volume of micropores and small capillary pores. This effect is more pronounced for nanosilica with higher surface area. For instance, the direct addition of NS300 increased the pore volume, while its coated form decreased the pore volume, indicating that utilizing nanosilica particles in their coated form successfully alleviates the agglomeration problem and greatly improves their dispersion within the cement matrix.

### CONCLUSIONS

This Example demonstrates the effectiveness of coating nanosilica on the limestone surface in better dispersion of nanoparticles and improving the overall performance of the cement-based materials. The nanosilica-coated limestone composites were prepared by the wet coating method using nanosilica particles with different specific surface areas (NS90: 90 m²/g and NS300: 300 m²/g).

Based on the results, the following conclusions can be drawn:
1. Coating nanosilica on limestone particles can significantly reduce the amount of HRWR required to maintain workability of cement-based mixtures, which is beneficial both economically and environmentally.
2. Compared to nanosilica added separately, nanoparticles coated on the limestone surface exhibited superior performance in reducing CH content, refining pore structures, requiring less HRWR, and improving mechanical strength.

These findings provide important information for the development of sustainable and high-performance cement-based materials.

What is claimed is:

1. A method of making concrete, the method comprising mixing one or more cementitious materials with an activator in amounts and for a time effective to form the concrete, wherein the one or more cementitious materials comprise composite particles comprising an inert core and a reactive surface.

2. The method of claim 1, wherein the inert core of the composite particles comprises limestone.

3. The method of claim 2, wherein the limestone is produced through a carbon mineralization process.

4. The method of claim 2, wherein the limestone is not pyro-processed.

5. The method of claim 1, wherein the reactive surface of the composite particles comprises pozzolanic material.

6. The method of claim 5, wherein the pozzolanic material comprises nano-SiO₂ (nanosilica) particles.

7. The method of claim 1, wherein the one or more cementitious materials comprise up to 50 wt. % of the composite particles.

8. The method of claim 1, wherein the reactive surface of the composite particles is converted to a binder to cement the composite particles together.

9. The method of claim 8, wherein the reactive surface of the composite particles is converted to the binder through pozzolanic reactions.

10. The method of claim 1, wherein the composite particles are made by coating the inert core with the reactive surface in a solution.

11. The method of claim 10, wherein the solution is a calcium salt solution.

12. The method of claim 11, wherein the calcium salt solution has a calcium concentration and pH wherein the inert core and the reactive surface possess opposite surface charges.

13. A method of making concrete, the method comprising mixing one or more cementitious materials with an activator in amounts and for a time effective to form the concrete, wherein the one or more cementitious materials comprise composite particles comprising an inert core comprising non-pyro processed limestone and a reactive surface comprising silica nanoparticles.

14. The method of claim 13, wherein the composite particles are made by coating the inert core with the reactive surface in a solution.

15. The method of claim 14, wherein the solution is a calcium salt solution.

16. The method of claim 15, wherein the calcium salt solution has a calcium concentration and pH wherein the limestone of inert core and the silica nanoparticles of the reactive surface possess opposite surface charges.

17. A composition of matter comprising: an inert core comprising non-pyro processed limestone and a reactive surface comprising silica nanoparticles.
